(19) United States
(12) Patent Application Publication
(10) Pub. No.: US 2004/0069850 A1
(43) Pub. Date: Apr. 15, 2004

(54) Truck cargo management rfid tags and interrogators

(76) Inventor: Eric D. De Wilde, Anaheim, CA (US)

Correspondence Address: CHRISTIE, PARKER & HALE, LLP, 350 WEST COLORADO BOULEVARD, SUITE 500, PASADENA, CA, 91105, US

(21) Appl. No.: 10/470,289

(22) PCT Filed: Jan. 31, 2002
(86) PCT No.: PCT/US02/02989

(51) Int. Cl. G06F 17/60

(52) U.S. Cl. 235/385

(57) ABSTRACT

Correct removal of cargo units 14 from the cargo space 10 of a cargo delivery vehicle uses RFID tags 15 on the cargo units. A RFID transceiver 18 is in the cargo space. A sensor 16 responds to closure of a door to the cargo space to initiate operation of the transceiver to interrogate the RFID tags and to create an inventory of the cargo units then in the space. An inventory created upon door closure at each delivery location of the vehicle is compared to the last prior inventory, and differences identified by the

### FIELD OF THE INVENTION

This invention pertains to equipment and procedures for management of cargo movement into and out of the cargo space of a cargo transport vehicle. More, particularly, it pertains to equipment and procedures for accurately handling, and monitoring and recording the handling, of cargo units each of which carries an RFID tag by which the units are individually identified.

### BACKGROUND OF THE INVENTION

It is now known to equip trucks of various kinds with telemetry and communications equipment useful to provide information from the truck to a location remote from the truck. The remote location can be a central dispatch and control station from which the operation of a fleet of trucks is directed and managed. The information supplied to such a central station can include information about individual truck location and status. Status information can include data describing whether the truck is stationary or moving and, if moving, in what direction at what speed. In the instance of trucks operated by express document and parcel delivery services, information supplied from a truck to a central station can be information reporting the delivery of a specific item at a particular location; information descriptive of a specific item can be obtained by scanning an optical bar code on the item and converting that data into an electronic digital form suitable for transmission by radio or other wireless communication system.

Trailers of heavy duty trucks, as well as other kinds of trucks, are increasingly instrumented to sense, monitor and report on various conditions. Those conditions can include brake system state or condition (especially for ABS—automatic braking system—components)and cargo space conditions such as temperature and humidity. Information about those and other conditions can be transmitted from the trailer or cargo space to the driver=s station via power line communication (PLC) techniques, or in other ways, for recording and/or display. Information so recorded can be stored for analysis when the truck reaches its destination or a fleet terminal; that information can be transmitted by a wireless communication system to a central dispatch station, if desired, either on command by the driver or on interrogation of the truck from the central station.

Vehicle location information conveniently is obtained by use of a GPS (geophysical positioning system) transponder on the vehicle.

On a related front, radio frequency and other forms of wireless product identification devices and systems are increasingly used worldwide in a variety of ways to serve assorted purposes and functions. RFID tags can be passive or active. RFID tags can be defined to incorporate desired identification data before they are applied, as by self-adhesive means, to products or packages. RFID tags can be wirelessly interrogated by suitable radio frequency transceivers which, depending upon the nature of the tags and the transceivers, can be more or less spaced from each other. Applications for RFID tags include inventory control, antitheft purposes, article location, among many other applications.

On a further related front, operators of cargo delivery systems and services have need of improved systems, equipment and techniques for assuring prompt and accurate delivery of packages and parcels entrusted to them for delivery to assorted destinations. Operators of fleets of trucks are an example. It is not uncommon for such operators to experience misdelivery of packages or parcels arising out of handling errors by the drivers of those trucks. Misdelivery of a packagc results in delays in the arrival of packages at their intended destinations, damage to misdelivered packages, or even loss of the packages. The nature and extent of consequential damage and loss to fleet operators and their customers is apparent. A need exists for effective and efficient ways to prevent or significantly reduce misdelivery of packages by trucking firms.

### SUMMARY OF THE INVENTION

This invention addresses the need identified above. It does so by combining features, functions and benefits of RFID tags and systems with telemetry and communications systems now available to and used by truck operators, notably operators of truck fleets. This invention provides simple, effective and efficient equipment and procedures by which incipient misdelivery of a parcel by a trucking service can be detected and corrected before it becomes an actual misdelivery. For the most part, the different components of the equipment are commercially available and have established reliability.

Generally speaking, the structural aspects of this invention are provided in the context of a cargo delivery vehicle having a cargo space accessible via a closable door. In that context, apparatus according to this invention includes a door closure sensor which is operative to produce a signal indicative of closure of the door. A RFID tag interrogator transceiver is operative to interrogate, and receive data responses from, RFID tags which may be present on individual units of cargo in the cargo space. A data processor has a memory and is operative to receive and record data responses from the RFID interrogator transceiver.

Procedurally, this invention provides a method for handling the movement of units of cargo into and out of the cargo space of a cargo delivery vehicle; individual cargo units carry a wirelessly readable tag containing data identifying its unit. In that context, the method includes the step of creating, at an origin location of the vehicle, and at each subsequent delivery location of the vehicle following removal and addition of cargo units from and to the cargo space at the delivery location, an inventory of cargo units in the space. Further, by reading of the tags on cargo units in the space at each delivery location, the method includes the further steps of comparing the inventory created at that location with the last-preceding inventory, identifying differences between the compared inventories, and alerting the vehicle operator in the event that identified differences do not match a listing of cargo units scheduled for delivery at that location.

Another procedural aspect of this invention provides a method for handling the movement of units of cargo into and out of the cargo space of a cargo delivery vehicle, individual cargo units carrying a RFID tag embodying data identifying its unit. In that context, the method includes the step of creating a delivery schedule comprising a list of the cargo units to be removed from the cargo space at each of at least one delivery location of the vehicle. Another step of the method is placing in the cargo space, at a vehicle origin location, the cargo units listed on the delivery schedule. Another step is creating in the vehicle, by reading of the RFID tags, an inventory of cargo units in the cargo space. Further steps, performed at each delivery location of the vehicle, are reading of the RFID tags, and creating an adjusted inventory reflective of the removal of cargo units from the cargo space and of the addition of cargo units to the space. Also, at each delivery location, the method includes the further steps of comparing the adjusted inventory and the delivery schedule list, and creating a location report identifying each cargo unit then in the space which is listed for delivery at that location and each cargo unit not then in the space which does not correspond to a cargo unit listed for delivery at that location. If there are any entries on the pertinent location report, the vehicle operator is alerted while the vehicle is at that delivery location, so that identified cargo units which should have been removed from the cargo space at that delivery location can be removed from the space, and so that identified cargo units which were removed from the cargo space, but should not have been removed at that delivery location, can be returned to the cargo space.

### DESCRIPTION OF THE DRAWING

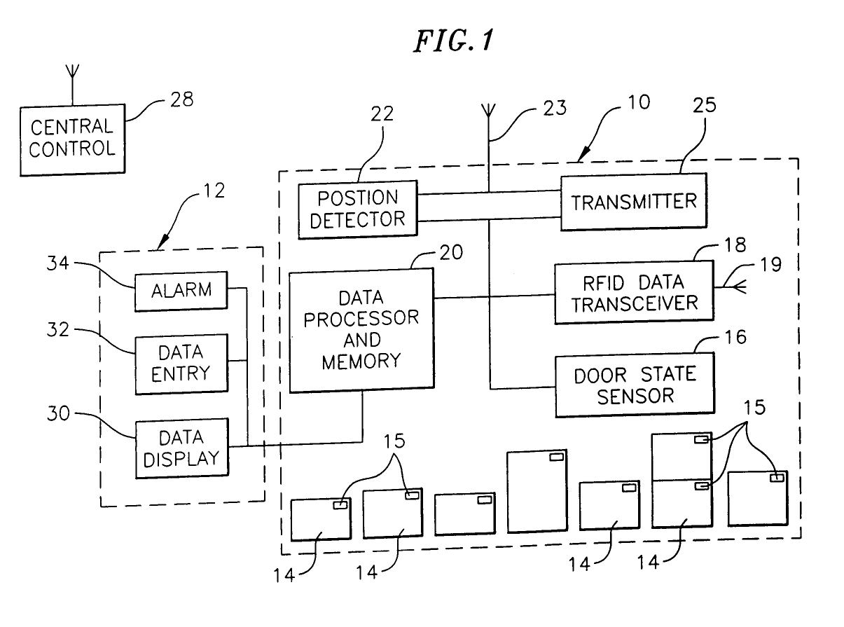

The foregoing and other features and aspects of the invention are set forth in the following detailed description which is presented with reference to the accompanying drawing in which FIG. 1 is a schematic depiction of the nature and interrelation of structures and devices useful to implement and enable practice of the structural and procedural aspects of the invention.

### DETAILED DESCRIPTION WITH REFERENCE TO THE DRAWING

A cargo space 10 of a cargo delivery vehicle, and an operator station 12 of the vehicle, are represented in the drawing. The delivery vehicle can be and preferably is a truck which can be of the single chassis kind or the multiple chassis kind. If the vehicle is of the multiple chassis kind, the cargo space is defined within a trailer to which a tractor is removably connectible in a known manner; the operator station is in the tractor in that instance.

As is well known, heavy duty truck tractors and truck trailers are mechanically and electrically interchangeably interconnectible to each other. Electrical interconnections between a truck tractor and trailer, or between trailers in a multiple trailer arrangement, are established by multiple conductor cables connectible between the tractor and a trailer, e.g., by use of standardized electromechanical connectors. Standardization of the mechanical and electromechanical connectors of truck tractors and trailers enables any tractor to effectively connect to any trailer in North America, as well as elsewhere. Electrical connections between heavy duty truck tractors and trailers achieve standardization by compliance with SAE (Society of Automotive Engineers) Standard J560, first established in January 1951 and last revised in June 1993. According to that standard, there are seven conductors in the electrical cable, and each of those conductors has its own individual connection to the tractor or trailer through connectors conforming to SAE J560. To provide for full interchangeability between tractors and trailers, those seven conductors have different functions assigned to them pursuant to SAEJ 560. One of those conductors is a ground conductor and the others are electrical power conductors associated with defined circuits and electrical functions in the trailer.

It will be understood that cargo space 10 is accessible via a closable door. Through that door individual cargo units 14 are placed into the cargo space or removed from the cargo space. The cargo units can be individual packages or parcels, or they can include pallets carrying one or more articles. In the practice of this invention, it is preferred that each cargo unit 14 carry on its exterior a RFID tag 15. The nature of RFID tags is well established and they now are readily available from a number of sources in the United States and elsewhere. Each RFID tag 15 embodies data which individually identifies the cargo unit by which it is carried. The tags can be applied to the cargo units in any suitable manner, such as self-adhesively. RFID tags can be passive or active. If passive, an RFID tag uses energy transmitted to it by a suitable transceiver to transmit the data embodied in the tag back to the transceiver. If the tag is active, it includes a small battery adequate to enable the tag to send to the transceiver data embodied in the tag in response to receipt by the tag of a command from the transceiver. Transceivers effective to simultaneously query and receive responses from many RFID tags, passive or active, are known.

Cargo space 10 includes, in association with the access door to the cargo space, a door state sensor 16. Door state sensor 16 is operative to generate a signal indicative of closure of the door. If desired, the door state sensor may also be operative to generate a signal, which can be different from the door closure signal, indicative of movement of the door from a closed to an open state. Signals generated by the door state sensor are applied to an RFID data transceiver 18 which has an antenna 19 located within the cargo space. Upon receipt of a signal from the door state sensor, transceiver 18 is operative to transmit within the cargo space radio frequency energy of a nature which causes RFID tags 15 on cargo units 14 within the cargo space to transmit data which identifies each of the cargo units. Cargo unit identifying data received by the transceiver is applied to a data processor and memory unit 20 which, as illustrated, preferably is located within or in close association to cargo space 10. Data received by data processor and memory unit 20 from the transceiver, in response to each tag interrogation operation of the transceiver, is processed by unit 20 and placed into its memory as an inventory of the cargo units ire the cargo space. The memory of data processor and memory unit 20 has sufficient capacity to store plural inventories. The inventories stored in the memory of unit 20 can be recalled from memory, either individually or in the order in which they were created and placed in memory.

Also, as shown in the drawing, cargo space 10 preferably has associated with it a position detector 22, such as a GPS (Global Positioning System) receiver which, via an external antenna 23, receives from GPS satellites information by which position detector 22 can determine the geographic position of the cargo space. Position identifying information is supplied from detector 22 to data processor and memory unit 20, where it can be placed in memory. Position detector 22 can be operated each time RFID data transceiver 18 is operated to interrogate RFID tags within the cargo space, and position indicating data can be recorded in memory in association with each inventory data set recorded in memory.

Cargo space 10 also has associated with it, in the preferred practice of this invention, a transmitter 25. Transmitter 25 can share antenna 23 with position detector 22. The transmitter is operative to transmit from the cargo space to a central control location 28, such as a fleet dispatch center, selected information acquired by the transmitter from data processor and memory unit 20 and descriptive of the cargo units in the cargo space at that time, or at desired earlier times, and also data identifying the geographical position of the cargo space at those times. Transmitter 25 also can receive commands from central control location 28, such as commands calling for the transmitter to report selected information from the memory of unit 20 as may be desired by the central control location.

Operator station 12 of the vehicle preferably includes a data display device 30, a data entry device 32, and an alarm 34, all of which are coupled to data processor and memory unit 20. The data display and data entry devices and the alarm may be hard wired to unit 20 in the instance where operator station 12 and cargo space 10 are mounted on the same vehicle chassis. However, if the operator station is within a heavy duty truck tractor, the coupling between data processor and memory unit 20 and the system components in the operator station preferably is via the multiconductor electrical cable connected between the truck tractor and the truck trailer. In the latter instance, the coupling is accomplished via the common conductor in that cable, and, if desired, via additional cable conductors.

The electrical communications connections between the above-described system components in cargo space 10 and operator station 12 enable the flow of digital information to and from data processor and memory unit 20. Equipment and procedures for digital information communications between truck tractors and trailers via the standard tractor-trailer via the standard tractor-trailer interconnection cable are known. For example, to implement a mandate of the United States government's National Highway Traffic Safety Administration (NHTSA)to provide a warning lamp in the cab of a tractor to notify a driver of malfunctions in tractor and/or trailer anti-lock brake systems (ABS), the PLC4Trucks system, a power line communication (PLC) system, has been developed and is in increasingly widespread use in North America. The PLC4Trucks system was developed by a consortium composed of manufacturers of heavy duty truck tractors and trailers and of equipment for such vehicles. In one implementation of the PLC4Trucks system, an Intellon P485 chip can be used; such a chip is marketed by Intellon Corporation of Ocala, Fla. U.S. Pat. No. 6,127,939, e.g., is another source of descriptions and techniques providing digital communications between truck tractors and trailers via the standard tractor-trailer multi-wire electrical cable. See also SAE Recommended Practice J1708 issued in 1986 and last revised in October, 1993; that Recommended Practice document is titled “Serial Data Communications Between Microcomputer Systems In Heavy-Duty Vehicle Applications.”

Electrical power for operating system components 16, 18, 20, 22 and 25, associated with the cargo space, can be provided by the vehicle electrical system which, in the instance of a tractor-trailer combination, includes the multiple conductor cable between the tractor and trailer. Where the cargo space is defined within a truck trailer, which is separable from a tractor, it is preferred that the trailer includes a battery powered uninterruptable power supply for providing electrical power for system components 16, 18, 20, 22 and 25 during those times when tractor power is not available.

The provision of electrical power on a continuous basis to the system components in or associated with the cargo space is important to the loss prevention benefits provided by this invention. If the vehicle or trailer has been stolen, transmitter 25 can respond to inquiries from central control location 28 about the location of the vehicle or trailer. Where the cargo space is within a truck trailer, the availability of electrical power on a continuous basis to the cargo space system components enables the central control location to determine which cargo units are within the cargo space at times when power is not available to the cargo space from the tractor engine.

Data display device 30 can be either or both of a display screen or a printer. Data entry device 32 can be of a kind compatible with the data medium used to provide information to data processor and memory unit 20. Thus, data entry device 32 can include any one or more of conventional computer data entry devices such as a CD reader, a diskette reader, or a keypad or keyboard. Alarm 34 can provide either audible or visual, or both audible and visual notification to the vehicle operator that an event has occurred requiring attention to information provided to the operator by data display device 30.

The procedural aspects of this invention can be understood by assuming that the vehicle is operated by a delivery service from a base (or trip origin) location. Cargo units to be delivered are loaded into cargo space 10. Different ones of those cargo units are to be delivered from the vehicle at a number of delivery locations, to which the vehicle will be driven from the origin location by its operator. At the origin location, a delivery schedule can be created; the delivery schedule can include a list of the cargo units which are to be removed from the cargo space at each delivery location. The information constituting the delivery schedule can be recorded by the delivery service operator on suitable passive data storage media, such as a CD ROM, a computer diskette, or magnetic tape cassette, and given to the vehicle operator. By use of the data entry device in the operator station of the vehicle, the vehicle operator can load the delivery schedule into data processor and memory unit 20. The vehicle operator may also be given a hard copy of the delivery schedule. The vehicle operator then closes the access door to cargo space 10 and departs on his delivery route. When the cargo space door is closed, transceiver 18 interrogates and receives cargo unit identifying information from the RFID tags carried by each of the cargo units in the cargo space. As has already been noted in the preceding description, such operation of the transceiver results in the creation in the memory of unit 20 of an initial inventory of cargo units in the cargo space. On arrival at the first delivery location, the driver stops the vehicle, opens the cargo access door, and removes from the cargo space those cargo units designated by the delivery schedule for removal from the cargo space at that delivery location. The vehicle operator may, at the same time, receive from the delivery service customer additional packages or cargo units, each bearing its own RFID tag, which are to be delivered by the delivery service to other destinations. The vehicle operator places those incoming cargo units in the cargo space. The access door is then closed. Closure of the access door results in the creation in the memory of unit 20 of a new inventory of cargo units in the cargo space. The data processing components of unit 20 then operate to compare the new inventory with the initial inventory and to identify differences between the compared inventories. As a consequence of that inventory comparison, the data processor can create a difference report which it can compare to the delivery schedule for that delivery location. If comparison of the difference report and the delivery schedule listing for cargo units to be delivered at that delivery location do not match, then either or both of two things are true. First, one or more cargo units scheduled for removal from the cargo space at that delivery location have not been removed from the cargo space. Second, one or more cargo units not scheduled for removal from the cargo space at that delivery location has been removed from the cargo space. If either or both of those conditions are met, alarm 34 is activated to inform the vehicle operator that a misdelivery event has occurred at that delivery location and the misdelivery event is to be rectified before the vehicle departs from that location. Information about any cargo unit which is a cause for activation of the alarm, i.e. is a cause for entries on the different report to fail to match the listing on the delivery schedule for that delivery location, can be made known to the vehicle operator via data display device 30. Equipped with that specific information, it is easy for the vehicle operator to rectify the misdelivery situation. Rectification of a misdelivery situation will require that the access door to the cargo space be reopened. Once the vehicle operator has completed his activities to correct a misdelivery situation, the access door is closed, a new inventory of cargo units in the cargo space is created in the memory of unit 20, and that inventory can be compared to the last preceding inventory. If the misdelivery situation has in fact been corrected, there will be no mismatch between the resulting difference report and the delivery schedule listing for that delivery location. The delivery vehicle may then proceed to its next delivery location.

It will be apparent that at each delivery location, after initial removal of cargo units from the cargo space for delivery, a new cargo unit inventory can be generated, that inventory can be compared to the last previously generated inventory, a difference report can be created, and the vehicle operator can be informed if any misdelivery situation has occurred. That sequence of events can be repeated at each subsequent delivery location.

It will be apparent from the preceding descriptions that, if the vehicle in the course of movement along its delivery route, picks up any cargo units at a delivery location, those new cargo units will be included in the inventory created upon door closure at the location where they were picked up. If any added cargo units should be wrongly removed from the cargo space at a later delivery location, that error will be identified and the vehicle operator informed of it so that the operator can take appropriate corrective action.

It was noted above that RFID tags can be either passive or active. Active RFID tags can include their own sensors for monitoring temperature, vibration or shock levels which the associated cargo unit encounters, or sensors for detecting placement of a cargo unit in an undesired positional attitude, such as a violation of a THIS END UP label instruction on a cargo unit. Sensor-equipped active RFID tags can be used to monitor and report on conditions experienced by the tag. An accelerometer can measure the vibration or shock levels experienced by the tag and, by extension, the cargo unit to which it is attached. A memory in the tag can capture the peak acceleration or shock level experienced by the tag. If the cargo unit arrives at its intended location in a damaged condition, an examination of this peak shock level can be used to determine if the damage was the fault of the shipping agent or the shipper or the receiver. Temperature sensors are particularly useful on temperature sensitive cargo, such as frozen foods. An RFID tag equipped with a temperature sensor knows whether a shipment of frozen food thawed during shipment or after delivery. Position sensitive sensors can provide information about whether the shipper laid a box on its side when the box clearly bears a THIS END UP label. Information obtained by sensors associated with active RFID tags can be transmitted to transceiver 18 each time the transceiver is operated, and then supplied by the transceiver to the memory of unit 20 as an adjunct to each inventory created in memory in response to operation of the transceiver. Such information can be downloaded from the memory either by command from the central control location 28, either at any time during the course of a delivery sequence or upon completion of a delivery route, to create an event report to determine when, where and under what circumstances any troublesome events may have occurred to any cargo units present at any time in the vehicle cargo space during a specified delivery trip.

The preceding description is not intended to be an exhausted catalog of all structural and procedural forms in which this invention can be embodied, manifested or practiced. Rather, the foregoing description has been set forth with reference to an exemplary and presently preferred embodiment of the invention, for purposes of example and illustration. Persons skilled in the art to which this invention pertains will appreciate that variations in or additions to the structures and procedures described above can be pursued without departing from the scope of this invention.

In the claims:

1. In a cargo delivery vehicle operable along a route comprising plural delivery locations and having a cargo space accessible via a closable door and into which can be placed individual cargo units each carrying an identifying RFID tag, the structural combination which includes
a door closure sensor operative to produce a door closure signal indicative of closure of the door;
a RFID tag interrogator transceiver associated with the cargo space to interrogate and receive data responses from RFID tags present on individual cargo units in the cargo space, and
a data processor having a memory operative to receive and record data responses from the transceiver, the data processor being configured to create an inventory of cargo units in the cargo space for each door closure signal and to identify differences between the inventories created for successive door closure signals.

2. The combination of claim 1 including a transmitter on the vehicle coupled to the processor, and operative for transmitting to a remote location data received from the processor.

3. The combination of claim 1 including a vehicle position detector coupled to the processor.

4. The combination of claim 1 in which the vehicle has an operator station, and including a data displayer at the operator station coupled to the processor.

5. The combination of claim 4 including a processor data entry device at the operator station.

6. The combination of claim 5 in which the data displayer includes a data display screen.

7. The combination of claim 5 in which the data displayer comprises a printer.

8. The combination of claim 5 in which the cargo space is in a truck trailer and the operator station is in a truck tractor, and the data displayer is coupled to the processor via an electrical power connection between the tractor and the trailer.

9. A method for handling the movement of units of cargo into and out of the cargo space of a cargo delivery vehicle at plural delivery locations on a route of the vehicle, individual cargo units carrying a RFID tag containing data identifying its unit, the method comprising the steps of:
(a) creating at an origin location of the vehicle, and at each subsequent delivery location of the vehicle following removal and addition of cargo units from and to the cargo space at the delivery location, an inventory of cargo units in the space, and
(b) by reading of the RFID tags on cargo units in the space, at each delivery location,
(1) comparing the inventory created at that location with the last-preceding inventory,
(2) identifying differences between the compared inventories, and
(3) alerting the vehicle operator in the event identified differences do not match a listing of cargo units scheduled for delivery at that location.

10. The method according to claim 9 in which reading of the tags is accomplished via a RFID tag data transceiver in the cargo space.

11. The method according to claim 10 in which the step of identifying differences between the compared inventories includes reference to a delivery schedule which identifies the cargo units to be removed from the cargo space at each delivery location.

12. The method according to claim 11 in which the tag data transceiver is coupled to a data processor having a memory into which the delivery schedule is loaded at the origin location of the vehicle, and into which each inventory is loaded in connection with its creation.

13. The method according to claim 11 in which the step of alerting the vehicle operator includes the step of identifying to the operator each cargo unit which is a cause for identified differences failing to match a listing of cargo units scheduled for delivery at that location.

14. The method according to claim 13 in which the step of identifying cargo units causing a failure to match said listing includes supplying data thereon to a data displayer accessible by the operator.

15. The method according to claim 10 in which reading of the RFID tags is initiated in response to closure of an access door to the cargo space.

16. The method according to claim 15 in which the step of alerting the vehicle operator includes initiating operation of an alarm.

17. The method according to claim 16 in which any initiation of operation of the alarm occurs following closure of the door.

18. The method according to claim 10 including the further step of transmitting from the vehicle data identifying the cargo units then in the cargo space and the location of the vehicle.

19. The method according to claim 18 in which the step of transmitting can be initiated by a command originated at a place spaced from the vehicle.

20. A method for handling the movement of units of cargo into and out of the cargo space of a cargo delivery vehicle at plural delivery locations on a route of the vehicle, individual cargo units carrying a RFID tag embodying data identifying its unit, the method comprising the steps of:
creating a delivery schedule comprising a list of the cargo units to be removed from the cargo space at each delivery location of the vehicle,
placing in the cargo space at a vehicle origin location the cargo units listed on the schedule,
creating in the vehicle, by reading of the RFID tags, an inventory of cargo units in the cargo space,
at each delivery location of the vehicle, by reading of the RFID tags, creating an adjusted inventory reflective of the removal of cargo units from the cargo space and of the addition of cargo units to the space,
at each delivery location, comparing the adjusted inventory and the delivery schedule list and creating a location report identifying each cargo unit in the space which is listed for delivery at that location and each cargo unit not in the space which does not correspond to a cargo unit listed for delivery at that location, and
alerting the vehicle operator at each delivery location if there are any entries on the pertinent location report.
